(19) United States
(12) Patent Application Publication
(10) Pub. No.: US 2015/0321188 A1
(43) Pub. Date: Nov. 12, 2015

(54) Cartridge for the treatment of drinking water and method for treating drinking water

(71) Applicant: BWT AG, Mondsee (AT)

(72) Inventors: Jürgen JOHANN, Nussloch (DE); Monique BISSEN, Mondsee (AT)

(21) Appl. No.: 14/410,135

(22) PCT Filed: Jun. 28, 2013
(86) PCT No.: PCT/EP2013/063686

§ 371 Date: Dec. 22, 2014

(30) Foreign Application Priority Data
Jun. 28, 2012 (DE) 10 2012 105 723.0

(51) Int. Cl. B01J 39/18; C02F 1/42; C08F 122/10; C02F 1/00; B01J 39/04; C02F 1/28; C02F 1/50

(52) U.S. Cl. CPC B01J 39/185; C02F 1/283; C02F 1/42; C02F 1/505; C02F 1/285; C02F 1/003; B01J 39/046; C08F 122/10; C02F 2101/20

(57) ABSTRACT

A cartridge for treating drinking water with an ion-exchange material, wherein the ion-exchange material includes added silver, and wherein means for removing silver are arranged at the outlet of the cartridge.

### FIELD OF THE INVENTION

The invention relates to a cartridge for treating drinking water. The cartridge is in particular designed for use with a gravity-operated household water filter or as a cartridge for insertion into the feed conduit of a device for preparing beverages. The invention moreover relates to a method for treating drinking water.

### BACKGROUND OF THE INVENTION

For treating drinking water it is known to use cartridges, in particular filter cartridges. On the one hand, these filter cartridges are adapted for use in gravity-operated water filter systems such as those particularly employed in households. The cartridge sits in a hopper. Through an inlet, this hopper is filled with water which flows into the cartridge at an upper side thereof and leaves the cartridge through a lower outlet.

In other applications, for example in gastronomy or vending machines for preparing hot drinks, cartridges are used which are either inserted into a device or connected into a drinking water conduit by means of appropriate connections. The replaceable cartridges described above are usually used to reduce the hardness of water, especially the carbonate hardness of drinking water. For this purpose, the cartridge is filled with an ion-exchange material, for example a weakly acidic resin.

Furthermore, the cartridges may have the task of removing suspended particles or impurities, such as heavy metals, from the drinking water. In this case, the filter material comprises activated carbon and an ion-exchange material. Heavy metals such as lead, copper, or nickel are removed by ion exchange processes.

Since the cartridges are used over a rather long period of time, this may lead to contamination, for example due to growth of bacteria. The latter might be released into the filtered drinking water. Microbial contamination of the cartridge and hence also of the filtered water may for example be reduced or even avoided by partially loading the cartridge with antibacterial substances.

In particular cartridges are known which include silver or are impregnated with silver. Silver has an antibacterial effect and may thus counteract microbial contamination. The silver may be added to the bed of the cartridge in form of as a silver resin, silver salt, silver-containing activated carbon and/or in particulate form, for example.

During the filtration of drinking water, silver-containing cartridges release silver into the drinking water. The silver is slowly released into the water, the silver concentration is in a range from 50 to 150 ppb (parts per 10⁹). Downstream the water filter, the treated drinking water is substantially free of contaminants such as lead, copper, chlorine, etc., but contains silver due to the silver release from the water filter.

In particular after a period of stagnation, for example when the water remains in the filter overnight, concentrations of more than 200 ppb are obtained.

However, a release of silver into the drinking water is unfavorable, both under physiological and material science considerations. The silver-containing drinking water might cause electrochemical galvanic corrosion in downstream equipment. In this case, the process is similar to that in a battery. The less noble metal such as brass, copper, iron functions as an anode, the more noble silver functions as a cathode, that means silver will be deposited and the less noble metal will go into solution. During this process, the less noble metal dissolves. This causes localized corrosion induced by the silver, which is commonly referred to as pitting.

In addition to corrosion effects which have an adverse effect on the lifetime of the equipment described above, constituent materials of pipes and device components might go into solution and be released into the drinking water. This may lead to a release of lead, nickel, or copper into the drinking water.

### OBJECT OF THE INVENTION

Given the above, the invention is based on the object to further improve the known cartridges for treating drinking water. In particular it is intended to provide a cartridge that exhibits an antibacterial effect without considerably increasing the concentration of silver in the filtered drinking water.

### SUMMARY OF THE INVENTION

The object of the invention is already achieved by a cartridge for treating drinking water, a means for removing silver, and by a method for treating drinking water according to an illustrative embodiment of the present invention.

The invention relates to a cartridge for preparing drinking water.

The invention relates to a cartridge for a filter for treating drinking water, both in gravity-operated and in pressure-operated filters.

In gravity-operated water filters, the cartridge is usually inserted into a hopper into which the water to be filtered is filled.

Such a cartridge generally includes a housing having an inlet and an outlet. Preferably, a fleece is arranged at the outlet. Inlet and outlet may for example be formed as slots or as a grid structure.

The invention also relates to cartridges for use in devices for the preparation of beverages. In this case, the cartridge may be placed in the device or in front of the device, e.g. a coffee machine, for example in the inlet conduit of the device or in the outlet of a water tank.

Furthermore, the invention relates to filters which are arranged in particular within a water tank, for example in the water tank of a coffee machine. In case of the latter water filters, the water is sucked through from the water tank through the cartridge.

The cartridge comprises an antibacterial silver-containing ion-exchange material and a means for removing silver from the drinking water, and the drinking water first flows through the silver containing ion-exchange material and is subsequently treated using the means for removing silver.

It is known that in wet cartridges without antibacterial equipment, elevated bacterial concentrations, i.e. bacterial growth, may occur, in particular with increasing duration of use of the cartridge.

The addition of silver to the bed may for example be accomplished using silver resin (e.g. Purolite C 150 Ag), silver-containing activated carbon (e.g. Eurocarb YAO 15×50, 0.05 Ag), a silver-loaded ion-exchanger, or using a metallic silver (e.g. a silver-coated metal mesh).

The inventive cartridge for treating water, by contrast, has an antibacterial effect due to its silver content, i.e. bacterial growth in the cartridge is inhibited by release of silver into the drinking water. Furthermore, the cartridge comprises a means for removing silver, which will also be referred to as silver sorbent below, and which removes silver from the drinking water.

The cartridge is configured so that the drinking water which has previously passed through the silver-containing ion-exchange material and has been enriched with silver is contacted with the silver sorbent before flowing out of the cartridge. Due to the configuration according to the invention it is therefore possible to provide an antibacterially equipped cartridge without affecting the water quality by a release of cartridge constituents. Rather, the employed silver sorbent is preferably adapted to additionally actively reduce the concentration of other heavy metals such as lead, copper, cadmium, zinc so as to improve water quality. Thus, the drinking water flowing out of the cartridge is almost free of silver and therefore hygienically clean, has an enhanced physiological value and does not cause silver-induced corrosion in downstream equipment.

By virtue of the inventive configuration of the water filter, contaminants are removed from the drinking water, silver is added to the drinking water within the water filter and thus bacterial growth is inhibited. The drinking water delivered from the water filter, however, is almost free of silver.

It is particularly suggested that the silver sorbent is provided in form of a fleece, in particular in form of an ion-exchange fleece. In this case, the use of a carrier material has been found particularly advantageous. According to one embodiment, the fleece fibers have an average diameter of 5 to 30 microns, preferably 10 to 20 microns.

The provision of the silver sorbent in form of an ion-exchange fleece, in particular with the fiber diameters mentioned above, is advantageous when compared to a granulate material, since in case of a fleece the latter has a considerably larger specific surface area than a granulate material, which results in a better kinetics for adsorption of the silver from the drinking water.

The fleece may be formed as a multi-layered material, as contemplated according to one embodiment of the invention. Thus, different fleece layers may be inserted, one above the other, into the outlet of the filter cartridge. It is in particular conceivable to place a layer of a fleece having a high capacity for removing silver ions above a further layer which has a higher selectivity with respect to silver ions.

Moreover, the large pore volume enables a high throughput. This is particularly favorable for applications in devices for hot beverage preparation such as coffee machines in which high flow rates are required.

In one embodiment of the invention, the fleece comprises polyacrylate fibers. In particular, the fleece comprises fibers of modified polyacrylonitrile. These fibers are capable to adsorb silver and other heavy metals thereby removing them from the drinking water.

According to one embodiment, the modifying is accomplished by introducing at least one functional group which is capable of complexing silver and/or silver ions.

By virtue of the silver sorbent in form of a fleece and the arrangement of the silver-containing ion-exchanger and the fleece according to the invention it is possible to achieve maximum silver concentrations in the filtered drinking water of less than 100 micrograms per liter, preferably less than 80 micrograms per liter, and more preferably 10 micrograms per liter, and at the same time to have an antibacterially equipped cartridge.

By contrast, the methods for removing silver from the drinking water known from the prior art, for example using precipitation reactions, electrolysis, or specific ion exchangers, only permit to reduce the concentration of silver to about 100 micrograms per liter.

Another advantage of the inventive method is the compact, simple configuration. The silver sorbent can be integrated into the cartridge, while the methods known so far required both additional process steps and partly complex devices (e.g. in case of electrolysis).

Instead of a fleece for removing silver, it is possible according to an alternative embodiment of the invention to use a granulate material, for example an ion-exchange resin (e.g. Lewatit® MonoPlus TP 214, or Lewatit® MonoPlus TP 207). This generally requires a larger volume, since such granulate material exhibits a smaller specific surface area and therefore a much lower kinetics.

The invention further relates to a method for treating drinking water, in particular using the cartridge described above.

In the cartridge, the drinking water is passed through an ion-exchange material which at least partially includes silver, whereby the silver which has antibacterial activity is released into the drinking water resulting in a preservation of the material, or water, that is present in the cartridge. Subsequently, the water flows through a silver sorbent. The silver sorbent causes complexation of the silver, so that when delivered from the cartridge the drinking water has a maximum silver content of less than 30 micrograms per liter, preferably not more than 10 micrograms per liter, whereas in the region of the ion-exchange material the silver content may be more than 200 micrograms per liter.

Furthermore, the invention relates to a means for removing silver. In particular, a fibrous modified polyacrylate is provided as a so-called silver sorbent, which due to the modification includes active groups for complexing the silver. The silver is primarily removed from the water by complexation of elemental silver, and partially in ionic form or as an ion pair.

Chloride ions which are always present in drinking water may form insoluble colloids with silver. Even if the silver chloride concentration is so low that the solubility product of the silver chloride is not exceeded so that the silver does not precipitate as silver chloride, it will be present in the water as a neutral ion pair [Ag⁺Cl⁻]. Neither the colloidal silver nor the neutral ion pair can be removed by a conventional ion exchanger.

According to an advantageous modification of the invention, the silver sorbent is a modified polyacrylonitrile.

The silver sorbent is preferably polyfunctional, that means besides carboxyl groups it includes further active groups which form strong complexes with the silver that is present in form of silver chloride. In particular, the further active groups are sulfur-containing groups. Sulfur-containing groups form particularly stable complexes with silver. Depending on the specific sulfur-containing group, a stable complex can be obtained with silver, whose complexation equilibrium is strongly on the side of the complex. Thus, the maximum concentration of free silver is very low. It has been found particularly advantageous to introduce functional groups which have a sulfur function and an amino function on the same carbon atom. In this case, the complexing effect caused by the sulfur can be further enhanced by the amino groups. Preferably, the active groups in the silver sorbent are thioamide groups or 1-aminothiols.

Thus, the silver sorbent is capable to remove silver from the drinking water in ionic and non-polar form, i.e. in form of a silver cation, neutral silver, or neutral ion pair. By employing the silver sorbent according to the invention it is thus possible to substantially eliminate the silver in the drinking water.

### BRIEF DESCRIPTION OF THE DRAWINGS

FIG. 1 is a sectional view of a cartridge for a gravity-operated household water filter.

FIG. 2 shows the concentrations of silver at the outlet of a conventional silver-containing filter cartridge.

FIG. 3 shows a sectional view of a water tank with an integrated cartridge.

FIG. 4 shows a pressure-operated water filter that is inserted, for example, into the feed conduit of a coffee machine.

### DETAILED DESCRIPTION

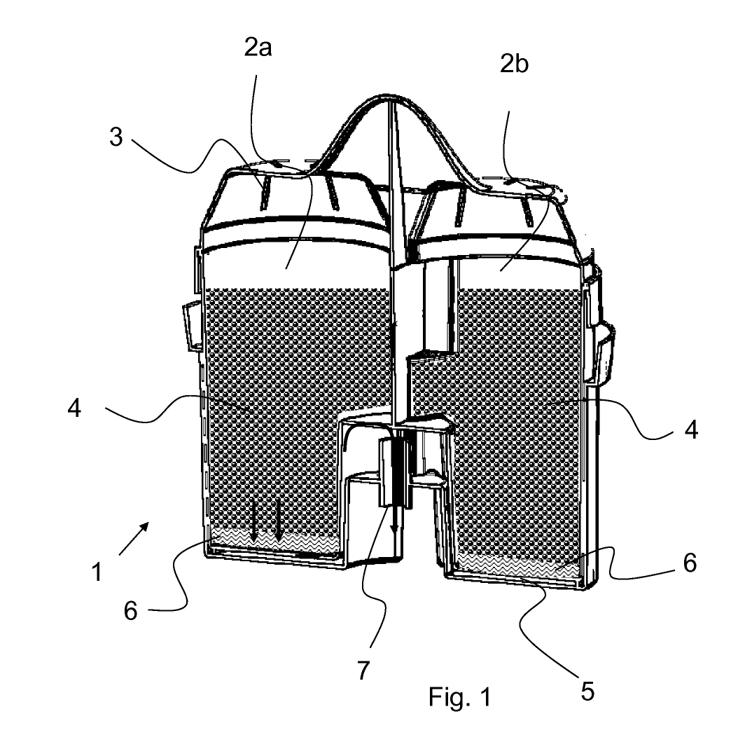

The invention will now be described in more detail with reference to the drawings of FIG. 1 to FIG. 4.

FIG. 1 is a sectional view of a cartridge for a gravity-operated household water filter such as those which can be inserted into a hopper.

In this exemplary embodiment, cartridge 1 is a cartridge having an inlet 3 and a chamber 2 which is filled with an antibacterial silver-containing ion-exchange material 4. Chamber 2 is divided into the two segments 2a, 2b arranged next to one another.

The ion-exchange material 4 is provided in granulated form. At the cartridge bottom 5, a fleece 6 is arranged which consists of a silver sorbent in form of a fleece. In this exemplary embodiment, the cartridge has an outlet 7 in form of a siphon. The fleece 6 is inserted in the two parts 2a, 2b of the chamber.

During the treatment of drinking water, the water enters chamber 2 through inlet 3 and passes through the ion-exchange material 4. Here the treatment of the drinking water is accomplished by ion-exchange processes, for example for water softening purposes. Simultaneously, the ion-exchange material 4 releases silver into the water. Subsequently, the water is passed through the fleece 6. Due to the contact with the silver sorbent, the silver included in the water is bound in the fleece 6. After having passed through fleece 6 the treated water leaves the cartridge through outlet 7 which is in form of a siphon.

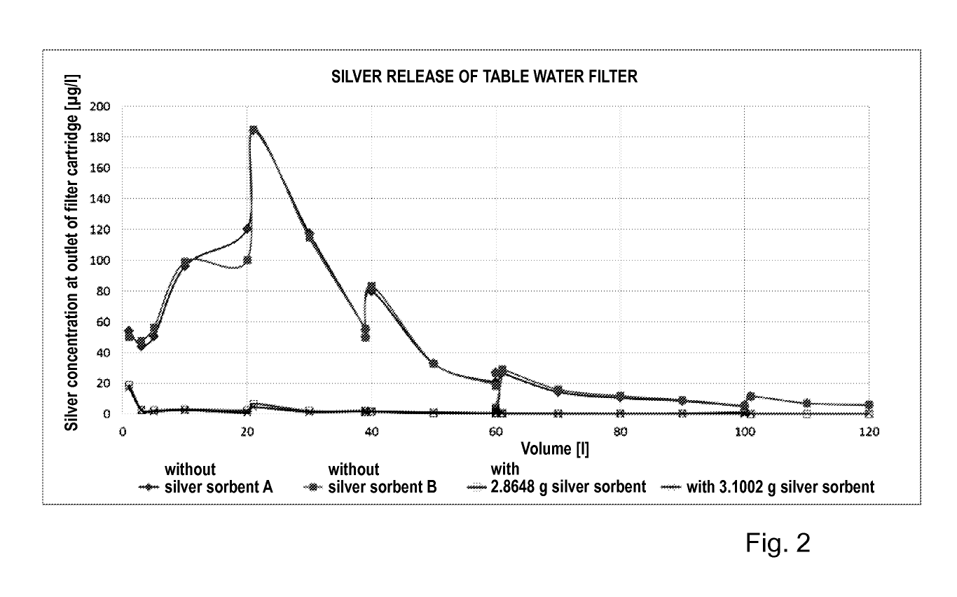

FIG. 2 shows the concentrations of silver at the outlet of a conventional silver-containing filter cartridge and of a cartridge according to the invention as a function of the volume of water filtered.

The silver concentration at the outlet of a conventional silver-containing cartridge, after an initial value of about 50 micrograms per liter, rises within the first 20 liters up to 180 micrograms per liter. Then, during the next 20 l, the silver concentration decreases to about 60 micrograms per liter. After a total of 40 l, the concentration increases again to 80 micrograms per liter. After a filtered total volume of 60 l, the silver concentration is about 20 micrograms per liter.

FIG. 2 clearly shows that when using conventional silver-containing cartridges, in particular within the first 40 liters of water the silver concentration is always above 50 micrograms per liter. Peak concentrations of up to 180 micrograms per liter are obtained. These high concentrations are alarming under physiological aspects. In addition, such high silver concentrations promote corrosion of metallic materials and promote pitting caused by redox processes.

When using a cartridge according to the invention, by contrast, the maximum concentration of silver is 20 micrograms per liter. This maximum value is reached at the start of filtration and falls quickly within a volume of a few liters to below 5 micrograms per liter. This low concentration of silver does not rise further, even after a total volume of 120 l of filtered water. Thus, the cartridge of the invention ensures antibacterial activity over a long period of use with a constant low concentration of silver in the so-treated water.

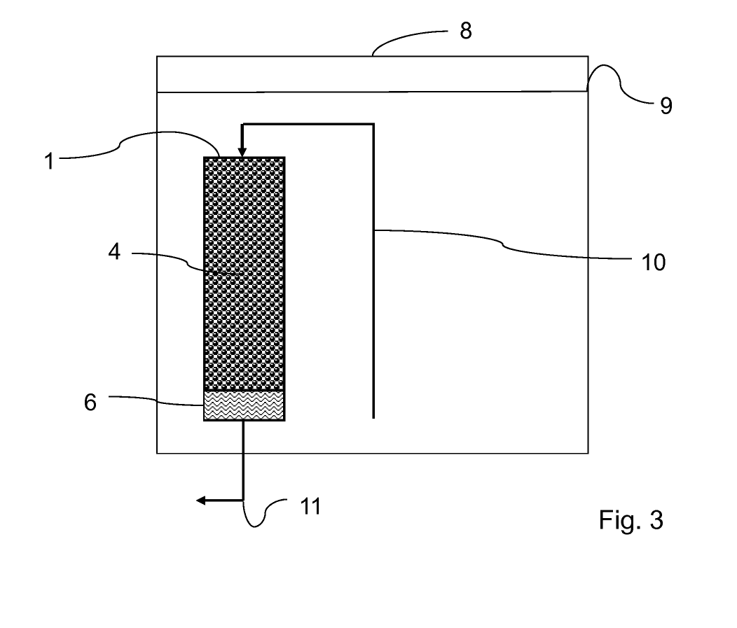

FIG. 3 shows a sectional view of a water tank 8 with integrated cartridge 1 according to the invention. Cartridge 1 of the invention sits at the bottom of water tank 8. The water enters cartridge 1 through inlet 10. The arrows indicate the direction of flow of the water. Inlet 10 suctions the water from the bottom or lower region of water tank 8. Then, the water is passed through the ion-exchange material 4 and thereafter through the silver 6 sorbent which is arranged at the bottom of cartridge 1 thereby being treated, before it leaves cartridge 1 and water tank 8 through outlet 11.

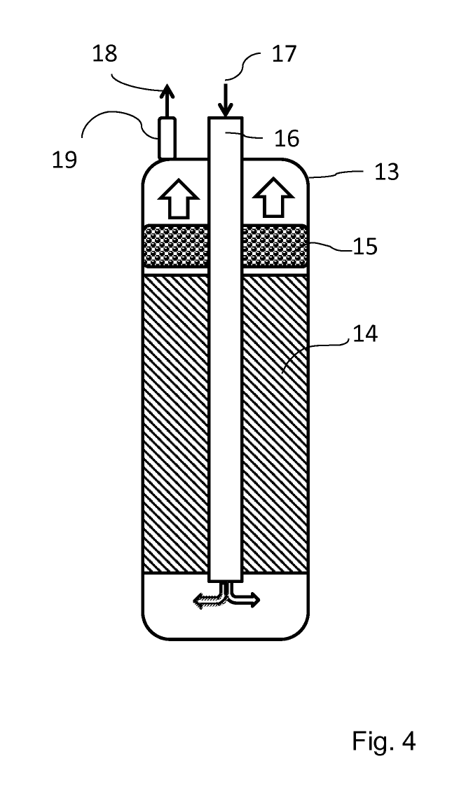

FIG. 4 shows a pressure-operated water filter 13 which is inserted, for example, into the feed conduit of a coffee machine. The water flows through inlet 17 through inlet pipe 16 into the water filter. Then, the water passes through the ion exchanger or activated carbon bed 14. Before being delivered from the filter, the water is passed through silver sorbent 15. The treated water 18 which is largely free of silver leaves the water filter 13 through outlet 19.

### LIST OF REFERENCE NUMERALS

1 Cartridge
2 Chamber
3 Inlet
4 Ion-exchange material
5 Cartridge bottom
6 Fleece
7 Outlet
8 Water tank
9 Water level
10 Inlet
11 Outlet
13 Pressure tank
14 Ion-exchange material/activated carbon bed
15 Silver sorbent
16 Inlet pipe
17 Inlet
18 Treated water
19 Outlet

What is claimed is:

1. An antibacterially equipped cartridge for treating drinking water, comprising:
at least one chamber including an ion-exchange material or activated carbon and silver, and a material for removing silver from the drinking water;
wherein the cartridge is configured so that the drinking water first flows through a region of the cartridge which contains the silver and the ion-exchange material or activated carbon and subsequently is treated using the material for removing silver.

2. The antibacterially equipped cartridge for treating drinking water as claimed in claim 1, wherein the material for removing silver removes silver in form of a silver cation, neutral silver, or neutral ion pair from the drinking water.

3. The antibacterially equipped cartridge for treating drinking water as claimed in claim 1, wherein the material for removing silver includes active groups for complexing silver in form of sulfur-containing functional groups.

4. The antibacterially equipped cartridge for treating drinking water as claimed in claim 1, wherein the material for removing silver is provided in form of a fleece.

5. The antibacterially equipped cartridge for treating drinking water as claimed in claim 4, wherein the fleece has a fiber thickness from 10 to 20 microns.

6. The antibacterially equipped cartridge for treating drinking water as claimed in claim 4, wherein the fleece comprises a polyacrylate.

7. The antibacterially equipped cartridge for treating drinking water as claimed in claim 1, wherein the ion-exchange material is provided in form of a granulate material.

8. The antibacterially equipped cartridge for treating drinking water as claimed in claim 1, wherein the ion-exchange material is provided in form of a fleece.

9. The antibacterially equipped cartridge for treating drinking water as claimed in claim 1, wherein the material for removing silver is adapted so that a silver concentration in the filtered drinking water is less than 100 micrograms per liter.

10. A method for treating drinking water, wherein the drinking water is first passed through an ion-exchange material which comprises silver and has an antibacterial effect, and is subsequently passed through a material for removing silver.

11. The method for treating drinking water as claimed in claim 10, wherein in the region of the ion-exchange material more than 200 ppb of silver is added to the drinking water, and wherein the silver concentration is reduced to below 80 ppb using the material for removing silver.

12. A material for removing heavy metals, comprising a fibrous polyacrylate, wherein the modified polyacrylate comprises at least one sulfur-containing functional group for complexing heavy metals.

13. The material for removing heavy metals as claimed in claim 12, wherein the sulfur-containing functional group is a functional group in which the sulfur is bound to a carbon atom which has an amino group.

14. The material for removing heavy metals as claimed in claim 13, wherein the sulfur-containing functional group is a thioamide or a 1-aminothiol.

15. The material for removing heavy metals as claimed in claim 13, wherein the polyacrylate is a modified polyacrylonitrile.

16. The material for removing heavy metals according to claim 12, wherein the heavy metal is silver, lead, copper, cadmium or tin.

17. The antibacterially equipped cartridge for treating drinking water as claimed in claim 3, wherein in said sulfur-containing groups sulfur is bound to a carbon atom that has an amino group.

18. The antibacterially equipped cartridge for treating drinking water as claimed in claim 17, wherein in said amino group is a thioamid or aminothiol.

19. The antibacterially equipped cartridge for treating drinking water as claimed in claim 4, wherein said fleece is embodied as an ion-exchange fleece.

20. The antibacterially equipped cartridge for treating drinking water as claimed in claim 6, wherein said polyacrylate is a polyacrylonitrile.

21. The material for removing heavy metals as claimed in claim 12, wherein the material is embodied as a fleece.
